(19) United States
(12) Patent Application Publication
(10) Pub. No.: US 2013/0145648 A1
(43) Pub. Date: Jun. 13, 2013

(54) FILTER GUIDE HAVING LATCH DEVICE OF FILTER COVER AND CLOTHES-DRYING MACHINE USING THE SAME

(71) Applicant: LG ELECTRONICS Inc., Seoul (KR)

(72) Inventors: Jeongyun KIM, Seoul (KR); Sangik LEE, Seoul (KR)

(73) Assignee: LG ELECTRONICS INC., Seoul (KR)

(21) Appl. No.: 13/709,316

(22) Filed: Dec. 10, 2012

(30) Foreign Application Priority Data
Dec. 8, 2011 (KR) 10-2011-0131006
Dec. 19, 2011 (KR) 10-2011-0137562
Jan. 5, 2012 (KR) 10-2012-0001670

(51) Int. Cl. D06F 58/22; F26B 21/00

(52) U.S. Cl. CPC D06F 58/22; F26B 21/003
USPC 34/524; 34/82; 55/428

(57) ABSTRACT

A clothes-drying machine includes a drum defining a cavity that receives clothes, a cabinet that houses the drum and defines an opening to enable loading and unloading of clothes, a door configured to open and close to enable and inhibit access to the opening, a filter assembly configured to filter foreign substances included in air exhausted from the drum, and a filter guide positioned at a portion of the cabinet that defines the opening and defining a conduit that receives at least a portion of the filter assembly. The filter guide includes a sensing mechanism configured to detect presence of the filter assembly in the conduit, a filter cover positioned within the conduit, and a securing member configured to secure the filter cover and allow the filter cover to move to an open position based on the sensing mechanism detecting the presence of the filter assembly in the conduit.

### CROSS-REFERENCE TO RELATED APPLICATION

Pursuant to 35 U.S.C. §119(a), this application claims the benefit of the Korean Patent Application No. 10-2011-0131006 filed on Dec. 8, 2011, Korean Patent Application No. 10-2011-0137562 filed on Dec. 19, 2011, Korean Patent Application No. 10-2012-0001670 filed on Jan. 5, 2012, all of which are incorporated herein by reference in their entirety.

### TECHNICAL FIELD

This application relates to a filter guide having a securing member that is configured to secure a filter cover in a closed position in order to prevent foreign substances from moving past the filter cover for safety, and a clothes-drying machine using the same.

### BACKGROUND

Generally, a clothes-drying machine is an electric appliance that evaporates water elements of washed clothes loaded into a drum (or a tub) thereof by supplying heated air to a drum to dry washed clothes.

The air exhausted from such a clothes-drying machine after evaporating moisture of washed clothes loaded in the drum may have the moisture of the washed-clothes inside. Such air becomes high temperature humid air. Drying machines can generally be classified based on the method of treating this high temperature humid air.

In other words, drying machines are classified into condensation-type drying machine and exhaustion-type drying machines. In a condensation type drying machine, high temperature humid air is heat-exchanged in a heat exchanger while circulated, without being exhausted outside, and the moisture contained in the high temperature humid air is condensed. In an exhaustion type drying machine, the high temperature humid air exhausted after passing through the drum is directly exhausted.

Meanwhile, the air exhausted from the drum after drying clothes can have foreign substances of the clothes such as lint. Such foreign substances can damage mechanical parts provided in the clothes-drying machine while passing through the mechanical parts or they may contaminate external air when exhausted outside. Accordingly, the air having passed the drum should also pass through a filter to remove the foreign substances therefrom.

Typically, such a filter is provided in a front portion of a drum to filter foreign substances contained in the air having passed a drum. When the clothes-drying machine is continuously used, foreign substances, such as lint, can be filtered by the filter.

Such a filter can interfere with the air flow if foreign substances like lint are filtered beyond a preset level. The filtered foreign substances have to be removed regularly from the filter. For such filter cleaning, a user separates the filter from the clothes-drying machine and removes foreign substances after a drying cycle or in a state where the operation of the drying machine is paused. After that, the user can mount the filter to the clothes-drying machine again.

Accordingly, the filter provided in the clothes-drying machine is configured of a filter assembly positioned under an introduction opening of the clothes-drying machine. The filter is inserted in a filter guide having an open top. When trying to exchange the filter assembly, the filter assembly is demounted from the filter guide to be cleaned. The clean filter assembly is inserted or a new filter assembly is inserted.

The filter guide has an open top to insert the filter assembly therein. In a state where the filter assembly is not inserted in the open top of the filter guide, a filter cover is provided in the filter guide to prevent foreign substances from coming into a duct.

In this instance, such a filter cover typically has a structure configured to be open by a force pushing the filter assembly when the filter assembly is inserted. Accordingly, in a state where the filter assembly is demounted, the filter cover maintains a closed state by using, for example, an auxiliary spring.

### SUMMARY

According to one aspect, a clothes-drying machine includes a drum defining a cavity that receives clothes to be dried by the clothes-drying machine, a cabinet that houses the drum and that defines an opening to enable loading of clothes into the drum and unloading of clothes from the drum, a door configured to open and close to enable and inhibit access to the opening, a filter assembly configured to filter foreign substances included in air exhausted from the drum, and a filter guide positioned at a portion of the cabinet that defines the opening and defining a conduit that receives at least a portion of the filter assembly. The filter guide includes a sensing mechanism configured to detect a presence of the filter assembly in the conduit, a filter cover positioned within the conduit defined by the filter guide and separated from the portion of the cabinet that defines the opening, and a securing member configured to secure the filter cover in the closed position and allow the filter cover to move to an open position based on the sensing mechanism detecting the presence of the filter assembly in the conduit. The filter cover is configured to prevent items from moving past the filter cover in the conduit when in a closed position.

Implementations of this aspect may include one or more of the following features. For example, the sensing mechanism may include a latch sensor or a latch trigger and the securing member comprises a latch. The sensing mechanism may be attached to the securing member. The sensing mechanism may be configured to detect an absence of the filter assembly in the conduit. The securing member may secure the filter cover in the closed position based on the sensing mechanism detecting the absence of the filter assembly in the conduit. The filter cover may include a filter hinge shaft projecting outward from opposite sides of the filter cover and configured to be rotatably coupled within a hinge shaft hole of the filter guide, and a latching part configured to be engaged by the securing member based on the securing member securing the filter cover in the closed position.

The filter cover may be configured to hingedly rotate about the hinge shaft hole to move up and down between the closed and open positions. The clothes-drying machine may further include a support part extending between the sensing mechanism and the securing member. The securing member may include a latching hook configured to engage the latching part in order to maintain the filter cover in the closed position based on the filter assembly being positioned outside of the conduit. The sensing mechanism may include a pressing projection configured to be pressed by the filter assembly based on the filter assembly being inserted into the conduit. The filter guide may include a pressing opening configured to allow at least a portion of the pressing projection to pass through, and a hook opening configured to allow at least a portion of the latching hook to pass through.

According to another aspect, a filter guide defines a conduit and is configured to receives a filter assembly. The filter guide includes a latch member coupled to the filter guide, and a filter cover positioned within the conduit and configured to move back and forth between an open position and a closed position. The filter cover is configured to prevent items from moving past the filter cover when in the closed position. The latch member maintains the filter cover in the closed position based on the filter assembly being located outside of the filter guide. The latch member enables the filter cover to move to the open position based on the filter assembly being inserted into the filter guide to a position that causes release of the latch member.

Implementations of this aspect may include one or more of the following features. For example, the latch member may be configured to rotate outward with respect to the filter cover based on the filter assembly being inserted into the filter guide to a position that causes release of the latch member. The latch member may include a body portion having an upper end that is rotatably coupled to the filter guide, a pressing projection positioned at an upper portion of the body portion and configured to be pressed by the filter assembly, and a latching hook positioned at a lower portion of the body portion and configured to maintain the filter cover in the closed position by supporting a bottom surface of the filter cover. The pressing projection may include an inclined surface that is inclined in a downward direction with respect to an inserting direction of the filter assembly. A bottom side of the latching hook may include an inclined surface that is inclined in an upward direction with respect to a rotating direction of the filter guide as it moves from the open position to the closed position. The latch member may further include a hinge shaft positioned at the upper end of the body portion, and the filter guide may include a coupling hole to rotatably couple the hinge shaft therein. The filter guide may include a pressing opening configured to allow at least a portion of the pressing projection to pass through, and a hook opening configured to allow at least a portion of the latching hook to pass through. The filter guide may include a front member having a front side wall and a rear member having a rear side wall. The front and rear members may be assembled together. The pressing opening may be defined in the front side wall of the front member, and the hook opening may be defined in the rear side wall of the rear member. The latch member may be one of a pair of latch members provided on opposite sides of the filter guide. The filter cover may include a latching part configured to be engaged by the latch member based on the latch member maintaining the filter cover in the closed position. The filter cover may include filter hinge shafts projecting outward from opposite sides of the filter cover. A side wall of the filter guide includes a hinge shaft hole configured to rotatably couple the filter hinge shaft therein. The clothes-drying machine may further include a torsion spring positioned between the filter hinge shaft of the filter cover and the hinge shaft hole of the filter guide and configured to provide an elastic restitution force to the filter cover in a direction opposite of an inserting direction of the filter assembly.

According to another aspect, a clothes-drying machine includes a drum defining a cavity that receives clothes to be dried by the clothes-drying machine, a cabinet that houses the drum and that defines an opening to enable loading of clothes into the drum and unloading of clothes from the drum, a door configured to open and close to enable and inhibit access to the opening, a filter assembly configured to filter foreign substances included in air exhausted from the drum, and a filter guide positioned at a portion of the cabinet that defines the opening and defining a conduit that receives at least a portion of the filter assembly. The filter guide includes a filter cover positioned within the conduit and configured to move back and forth between an open position and a closed position, a pair of latch members provided on opposite sides of the filter guide, and a latching hook configured to maintain the filter cover in the closed position by supporting a bottom surface of the filter cover. The filter cover is configured to prevent items from moving past the filter cover when in the closed position. Each of the pair of latch members has a pressing projection configured to be pressed by the filter assembly. The pair of latch member maintains the filter cover in the closed position based on the filter assembly being located outside of the filter guide. The pair of latch member enables the filter cover to move to the open position based on the filter assembly being inserted into the filter guide and pressing the pressing projection of each of the pair of latch members. Pressing the pressing projection causes the latching hook to disengage from the filter cover.

It is to be understood that both the foregoing general description and the following detailed are exemplary and explanatory.

### BRIEF DESCRIPTION OF THE DRAWINGS

The accompanying drawings, which are included to provide a further understanding of the disclosure and are incorporated in and constitute a part of this application, serving together with the description to explain various aspects of technology. In the drawings:

FIG. 1 is a schematic diagram of a clothes-drying.

FIG. 2 is an exploded perspective view illustrating a coupling state of a filter guide provided in the clothes-drying machine.

FIG. 3 is a perspective view illustrating a latch member coupled to the filter guide.

FIG. 4 is a perspective view illustrating a closed state of a filter cover provided in the filter guide.

FIG. 5 is a specific perspective view illustrating the latch member provided in the filter guide.

FIG. 6 is a sectional view illustrating a closed state of the filter cover provided in the filter guide;

FIG. 7 is a perspective view illustrating an open state of the filter cover provided in the filter guide.

FIG. 8 is a diagram illustrating an inserted state of a filter assembly with respect to the filter guide.

FIG. 9 is an enlarged sectional diagram illustrating an operation of the latch member when the filter assembly is inserted in the filter guide.

FIG. 10 is a sectional diagram illustrating an open state of the filter cover provided in the filter guide.

### DETAILED DESCRIPTION

Referring to the accompanying drawings, a filter guide having a latch device for a filter cover and a clothes-drying machine using the same will be described in detail as follows.

Reference will now be made in detail to various specific implementations and examples, illustrations of which are provided in the accompanying drawings. In general, the same reference numbers are used throughout the drawings to refer to the same or like parts.

This application relates to a filter guide having a filter assembly of a clothes-drying machine mounted thereto. Accordingly, detailed descriptions of structural parts other than the filter guide will be omitted.

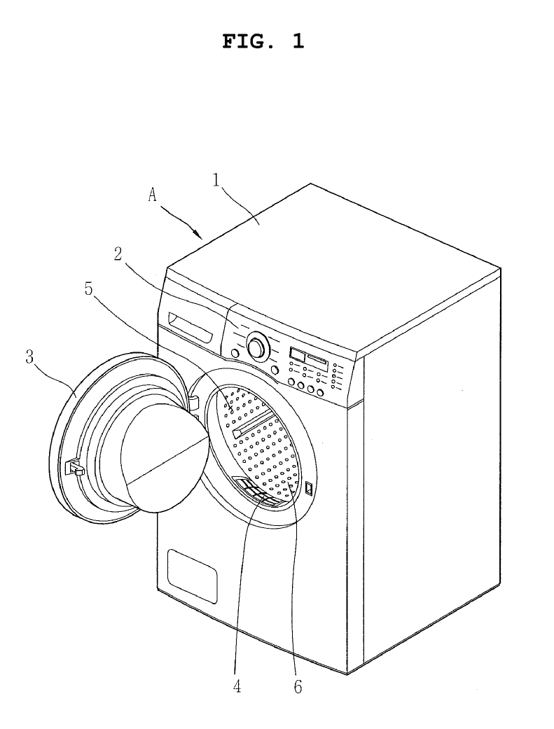

Referring to the accompanying drawings, a clothes-drying machine according to this application will be described. FIG. 1 is a diagram schematically illustrating a clothes-drying machine according to one implementation.

As shown in FIG. 1, a clothes-drying machine A according to one implementation includes a cabinet 1 having a door 3 coupled to a front surface thereof and a drum 6 rotatably mounted in the cabinet 1, with a plurality of lifters (not shown) projected from an inner circumferential surface thereof. In addition, the clothes-drying machine includes a control panel 2 provided in a front surface of the cabinet. A display window and an operational button are provided in the control panel 2.

A circulation duct (not shown) is in communication with the drum 6 rotatable in the cabinet 1 by a drive-motor. Heated air is exhausted from the drum via the circulation duct in communication with a rear portion of the drum 6 to dry washed-clothes that are drying objects.

The air used in drying the clothes contains the moisture evaporated from the clothes to become humid air. The humid air is supplied to a filter entrance provided adjacent to an opening 5 of the cabinet in front of the front surface of the drum to pass a filter. Foreign substances that could be contained by the humid air may be filtered by the filter provided between a front portion of the drum and the circulation duct. Such air flow can be performed by a fan (not shown) provided in the circulation duct more efficiently.

Meanwhile, a heat exchanger for heat-exchanging with air circulating the circulation duct may be provided in the clothes-drying machine. The heat exchanger heat-exchanges with the circulating air and absorbs heat from the high temperature humid air. After that, the air condenses and removes the moisture contained in the high temperature humid air.

The dry air having the moisture removed there from is re-heated by the heat exchanger or a heater, to become a high temperature dry air. The high temperature dry air is re-supplied to the drum 6 along the circulation duct.

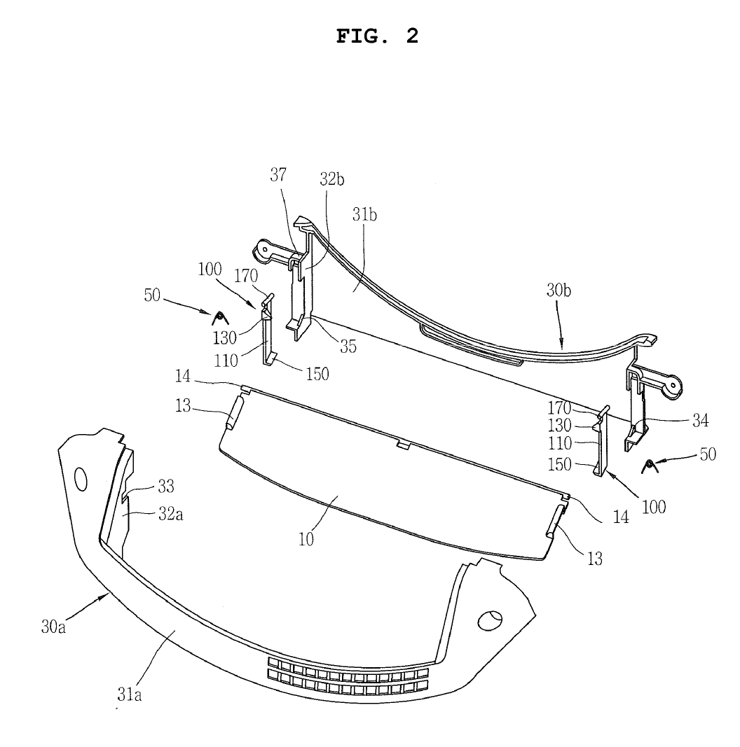

Referring to FIG. 2, a filter guide having a latch device for a filter cover and the clothes-drying device using the filter guide will be described in detail as follows. FIG. 2 is an exploded perspective view illustrating a coupling state of the filter guide.

Referring to FIG. 2, the drying machine according to one implementation may include a filter guide 30 having a filter assembly 70 configured to filter foreign substances contained in the air exhausted from the drum 6. The filer guide 30 can define a conduit that receives at least a portion of the filter assembly.

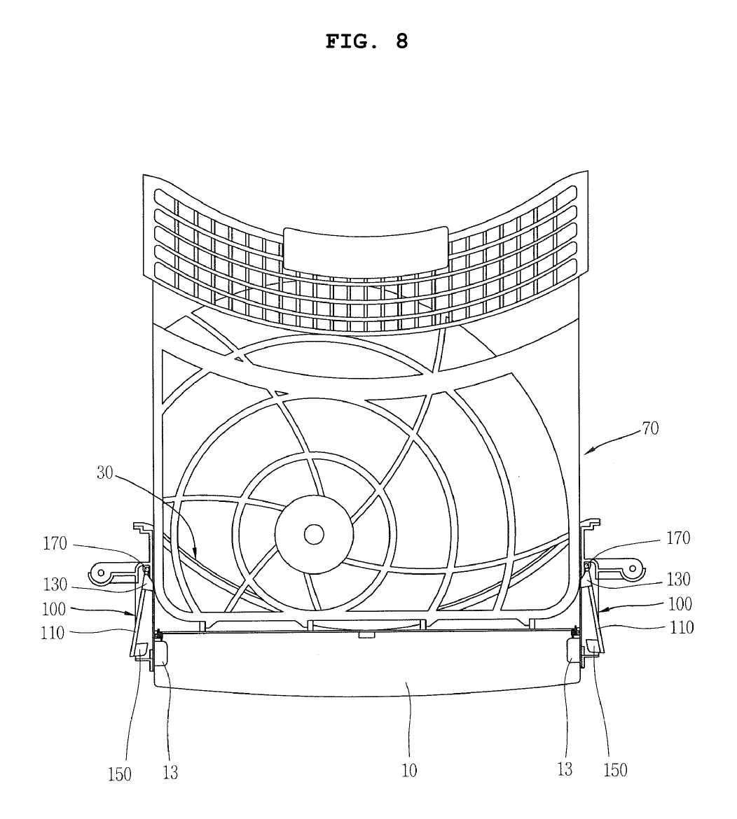

The filter guide 30 can be a member that forms a filter entrance 6 configured to insert the filter assembly (70, see FIG. 8) therein and the filter guide is provided under the opening 5, with an open top (see FIG. 1). When the filter assembly 70 is not inserted in the filter guide 30, the open top of the filter guide 20 is closed by the filter cover 10 such that items are prevent from moving past the filter cover.

The filter guide 30 can include a front member 30a and a rear member 30b that are assembled to each other. The front member 30a consists of a front plate 31a for defining a front surface and a front side wall 32a for defining a side wall. The rear member 30b consists of a rear plate 31b for defining a rear wall and a rear side wall 32b defining a side wall.

The filter guide 30 includes a filter cover that can be closed depending on the insertion of the filter assembly 70, a torsion spring 50 rotatable in a closing direction of the filter guide 30 when the filter assembly 70 is separated from the filter guide, and a latch device for the filter cover that limits the rotation of the filter cover 10 when the filter assembly 70 is separated from the filter guide 30 and releases the limitation on the filter cover 10 when the filter assembly 70 is inserted in the filter guide, thus making the filter cover rotatable.

Further, a hinge shaft hole is defined in each of lower portions of the filter guide 30 to have the filter cover 10 rotatably coupled thereto by a hinge. A latch member coupling hole 37 is define in each of upper portions of the filter guide 30 to rotatably support the latch member 100 of the filter cover latch device as will be described later. In this instance, the coupling state of the filter cover 10 and the installation state of the latch member 10 will be described in detail when the filter cover 10 and the latch member 100 are described.

The filter cover 10 typically has the structure configured to close the open top portion of the filter guide 30. In other words, when the filter assembly 70 is inserted in the filter guide 30, the filter cover is naturally open by the force generated by the inserted filter assembly 70. When the filter assembly 70 is separated, the filter cover is closed by auxiliary spring such as the torsion spring 50, without an additional external force. Also, the opening of the filter cover 10 is limited by the latch device for the filter cover, when the filter assembly 70 is separated.

In addition, the filter cover can hingedly rotate toward a rear side wall from the inside of the filter guide 30. Accordingly, the filter cover 10 includes a filter hinge shaft 14 projected from each of opposite sides. Such a filter hinge shaft 14 is inserted in hinge shaft holes 34 provided in both lateral walls of the filter guide 30 and hingedly rotates on the hinge shaft hole, to open and close the open top of the filter guide 30.

The torsion spring 50 may be further provided in the hinge shaft hole 34 of the filter guide 30 to apply an elastic restitution force to the filter cover to make the filter cover 10 maintain the closed state. Accordingly, the filter cover 10 is lifted by the elastic restitution force of the torsion spring 50 to maintain the closed state, in a state where the filter assembly 70 is not inserted, and it hingedly rotates downwardly to maintain the open state, in a state where the filter assembly 70 is inserted.

A latching part 13 is formed in each sides of the filter cover 10. As shown in FIG. 2, latching parts 13 are formed in both sides of the filter cover 10, to lock the filter cover from being open downwardly in the latch device for the filter cover.

The latch device for the filter cover is installed in each inner surface of the filter guide 30. Preferably, the latch devices are installed adjacent to the opposite filter hinge shafts 14 having the filter cover 10 hingedly coupled thereto, respectively. Such latch device for the filter cover may be formed by a pair of latch members 100. Such a pair of latch members 100 may be installed in opposite to both sides of the filter guide 30. Accordingly, only one of the latch members 100 will be described and description of the other one will be omitted.

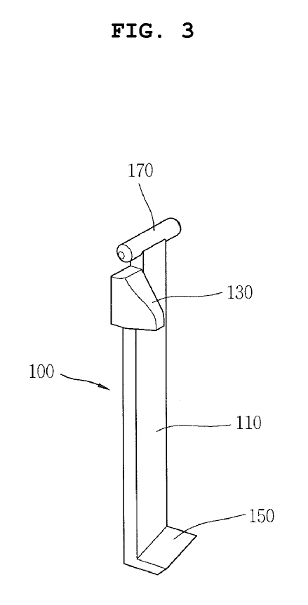

Referring to the accompanying drawings, the latch device for the filter cover will be described in detail as follows. FIG. 3 is a perspective view illustrating the latch member coupled to the filter guide.

As shown in FIG. 3, the latch member 100 composing the latch device for the filter cover includes a body part 110 formed of a plastic material extended in a vertical direction, with good ductility. A hinge shaft 170 is formed in a top of the body part 110 to be rotatably inserted in the latch member coupling hole 37 formed in the filter guide 30. A pressing projection 130 is formed in a lower portion of the hinge shaft 170 and the pressing projected part can be pressed by the filter assembly 70 when the filter assembly 70 is inserted. A latching hook 150 is formed in a lower portion of the body part 110 to support a lower portion of the filter cover 10 when the filter cover 10 is closed. The pressing projection 130 may be one type of a sensing mechanism that is configured to detect a presence and/or absence of the filter assembly in the conduit. Other types of sensing mechanisms may be used. In some cases, the sensing mechanism may be a latch sensor or a latch trigger. The latching hook 150 may be one type of a securing member that is configured to secure the filter cover in the closed position. Other types of securing members may be used. In some cases, the sensing mechanism may be attached to the securing member via the body part 110.

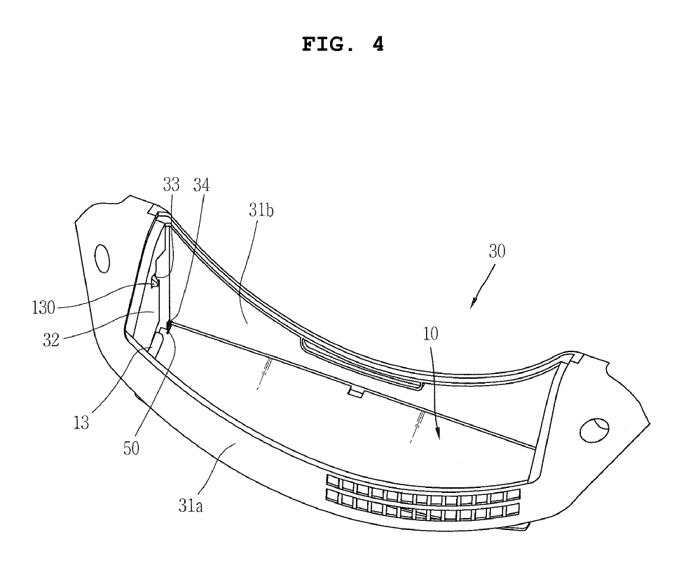

As illustrated in FIGS. 3 and 4, the pressing projection 130 and the latching hook 150 are projected into the filter guide 30 as they are assembled from the outside of the filter guide 30. To achieve this, a pressing opening 33 and a hook opening 35 may be defined in the filter guide 30 to expose the pressing projection and the latching hook 150. The pressing opening 33 may be positioned in an upper portion of an inner side wall composing the filter guide 30 and the hook opening 35 may be positioned in a lower portion of the inner side wall.

In other words, the latch members 100 can be installed in both outer portions of the filter guide 30 as shown in FIG. 2. The pressing projection 130 and the latching hook 150 may be projected from the side wall of the filter guide 30.

Accordingly, when the filter assembly 70 is inserted, the pressing projection 130 projected from each of the opposite inner walls composing the filter guide is pressed by the side wall of the filter assembly 70 in close contact. Subsequently, the latch member 100 rotates outwardly with respect to the filter assembly 70 along the hinge shaft 170 and the latching hook 150 positioned in the lower portion of the latch member 100 rotates outwardly with respect to the hook opening 35, thereby releasing the supporting state of the filter cover 10.

The operation of the filter guide having the latch device for the filter will be described as the filter assembly is mounted or demounted as follows.

Referring to FIGS. 4 to 6, the locking of the closed filter cover in the filter guide 30 will be described in detail as follows.

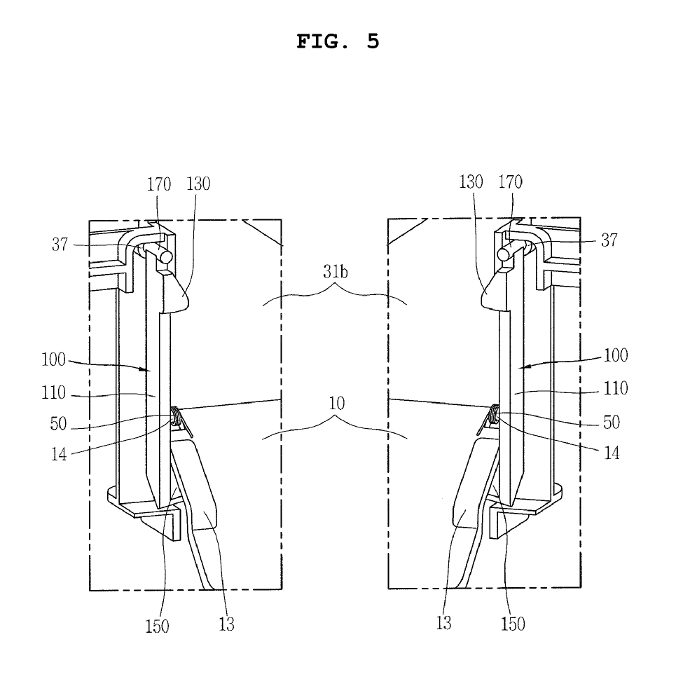

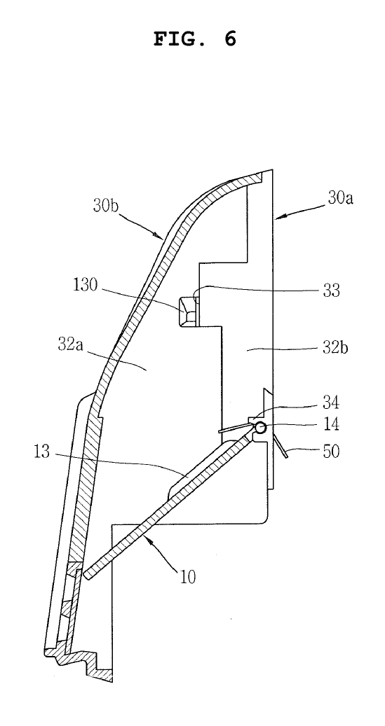

FIG. 4 is a perspective view illustrating the closed state of the filter cover provided in the filter guide. FIG. 5 is a specific perspective view illustrating the latch member provided in the filter guide. FIG. 6 is a sectional view illustrating the closed state of the filter cover provided in the filter guide.

Referring to FIGS. 4 to 6, the closed state of the filter cover 10 is maintained in the filter guide 30 in a state where the filter assembly 70 is not inserted.

In other words, a top of the latching hook 150 composing the latch member 100 hooks the latching part 13 of the filter cover 10 thereto to locks the opening of the latch member. A bottom of the latching hook 150 is an inclined surface to restitute the latching part 13 of the filter cover 10 to the closed state by using the elastic restitution force of the torsion spring 50 as the filter assembly is separated.

Specifically, when the filter assembly 70 is separated, the filter cover 10 is closed as rotated by the elastic restitution force of the torsion spring 50. Such an operation makes the latching part 13 of the filter cover 10 push the inclined surface formed in the bottom of the latching hook 150 upwardly to east the pressing part 13 of the filter cover 10 on a top surface of the latching hook 150.

Especially, the latching part 13 of the filter cover 10 is not hingedly rotated in a downward direction even when it receives the force in a state of being hooked to the latching hook 150 of the latch member 100 as shown in FIG. 5, such that the closing locked state of the filter cover may be maintained.

Accordingly, the filter cover 10 is closed in the open top space of the filter guide 30 as shown in FIG. 6. Even when the filter cover 10 is pressed from the top, the latching part 13 is hooked to the latching hook 150 not to move downwardly. As a result, the filter cover 10 is not opened even if foreign substances having the weight larger than the elastic restitution force of the torsion spring 50 are introduced. Therefore, foreign substances can be prevented from coming into the filter cover 10.

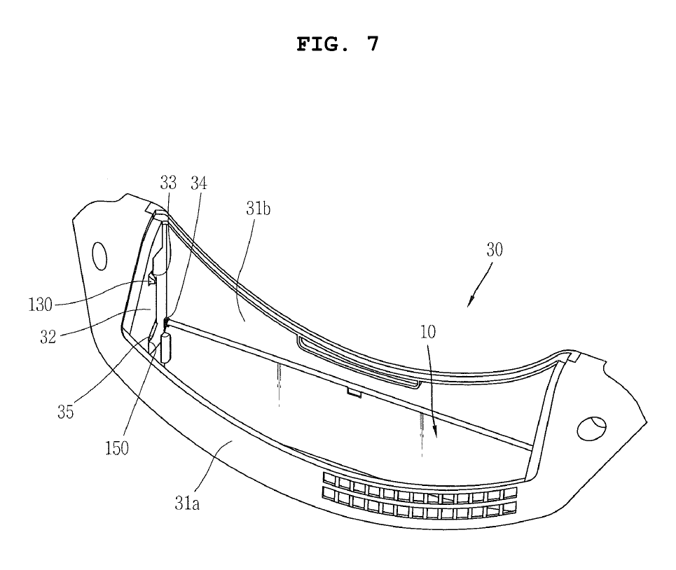

Referring to FIGS. 7 to 10, the closing locked state of the filter cover provided in the filter guide 30 will be described in detail as follows.

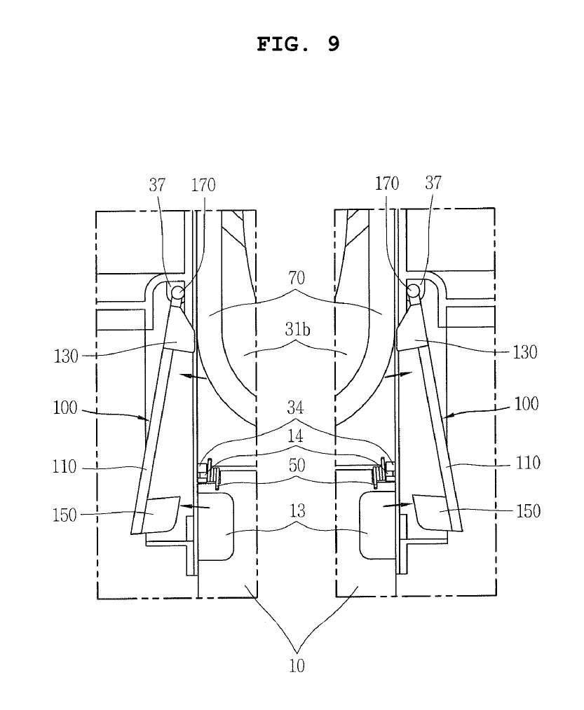

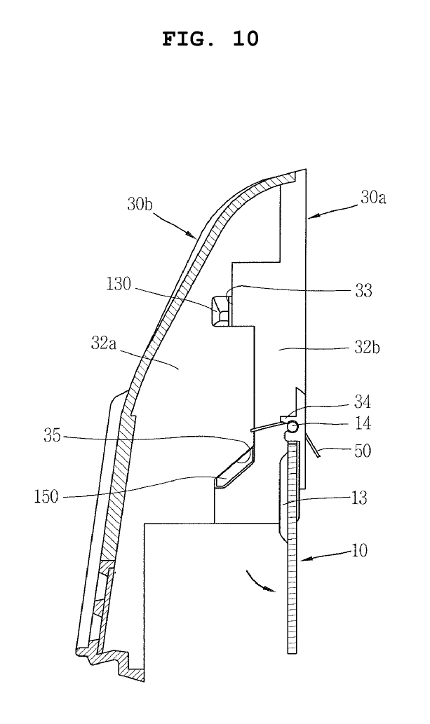

FIG. 7 is a perspective view illustrating an open state of the filter cover provided in the filter guide. FIG. 8 is a diagram illustrating an inserted state of a filter assembly with respect to the filter guide. FIG. 9 is an enlarged sectional diagram illustrating an operation of the latch member when the filter assembly is inserted in the filter guide. FIG. 10 is a sectional diagram illustrating an open state of the filter cover provided in the filter guide.

As shown in FIGS. 7 and 8, when the filter assembly 70 is inserted, the filter assembly 70 presses the pressing projection 130 toward the side wall thereof and the latching hook 150 is widened outwardly, thereby releasing the closing locked state of the latching part 13 provided in the filter cover 10.

In other words, when the filter assembly 70 is inserted in the open top space of the filter guide 30, both side walls of the filter assembly press the pressing projection 130 of the latch member 100 projected from both inner walls of the filter guide 30.

After that, as shown in FIG. 9, the body part 110 of the latch member 100 is pushed outwardly with respect to the hinge shaft 170 to separate the latching hook 150 from the latching part 13. Accordingly, the closing locked state of the filter cover 10 may be released.

The filter cover 10 is pressed by the filter assembly 70 moving downwardly and the filter cover 10 is hingedly rotated in a downward direction to be open as shown in FIG. 10, such that the filter assembly 70 may be completely inserted.

When the filter assembly 70 is separated, the filter cover 10 is hingedly rotated by the elastic restitution force of the torsion spring 50 in the reverse order described above, to be closed to close the open top space of the filter guide 30. Together with the separation of the filter assembly 70, the latch member 100 is hingedly rotated in an upward direction and it is latched to the latching part 13 of the filter cover 10 in a closed state.

The implementations described above are one of various exemplary implementations. This application is not limited by the implementations described above and the accompanying drawings. Various modifications are possible in the component parts and/or arrangements of the subject combination arrangement within the scope of the disclosure. In addition to variations and modifications in the component parts and/or arrangements, alternative uses may also exist.

What is claimed is:

1. A clothes-drying machine comprising:
a drum defining a cavity that receives clothes to be dried by the clothes-drying machine;
a cabinet that houses the drum and that defines an opening to enable loading of clothes into the drum and unloading of clothes from the drum;
a door configured to open and close to enable and inhibit access to the opening;
a filter assembly configured to filter foreign substances included in air exhausted from the drum; and
a filter guide positioned at a portion of the cabinet that defines the opening and defining a conduit that receives at least a portion of the filter assembly,
wherein the filter guide comprises:
a sensing mechanism configured to detect a presence of the filter assembly in the conduit,
a filter cover positioned within the conduit defined by the filter guide and separated from the portion of the cabinet that defines the opening, the filter cover being configured to prevent items from moving past the filter cover in the conduit when in a closed position, and
a securing member configured to secure the filter cover in the closed position and allow the filter cover to move to an open position based on the sensing mechanism detecting the presence of the filter assembly in the conduit.

2. The clothes-drying machine according to claim 1, wherein the sensing mechanism comprises a latch sensor or a latch trigger and the securing member comprises a latch.

3. The clothes-drying machine according to claim 1, wherein the sensing mechanism is attached to the securing member.

4. The clothes-drying machine according to claim 1, wherein the sensing mechanism is configured to detect an absence of the filter assembly in the conduit, and wherein the securing member secures the filter cover in the closed position based on the sensing mechanism detecting the absence of the filter assembly in the conduit.

5. The clothes-drying machine according to claim 1, wherein the filter cover comprises:
a filter hinge shaft projecting outward from opposite sides of the filter cover and configured to be rotatably coupled within a hinge shaft hole of the filter guide; and
a latching part configured to be engaged by the securing member based on the securing member securing the filter cover in the closed position,
wherein the filter cover is configured to hingedly rotate about the hinge shaft hole to move up and down between the closed and open positions.

6. The clothes-drying machine according to claim 5, further comprising a support part extending between the sensing mechanism and the securing member, wherein the securing member comprises a latching hook configured to engage the latching part in order to maintain the filter cover in the closed position based on the filter assembly being positioned outside of the conduit, and wherein the sensing mechanism comprises a pressing projection configured to be pressed by the filter assembly based on the filter assembly being inserted into the conduit.

7. The clothes-drying machine according to claim 6, wherein the filter guide comprises:
a pressing opening configured to allow at least a portion of the pressing projection to pass through; and
a hook opening configured to allow at least a portion of the latching hook to pass through.

8. A filter guide defining a conduit and configured to receive a filter assembly, the filter guide comprising:
a latch member coupled to the filter guide; and
a filter cover positioned within the conduit and configured to move back and forth between an open position and a closed position, the filter cover being configured to prevent items from moving past the filter cover when in the closed position,
wherein the latch member maintains the filter cover in the closed position based on the filter assembly being located outside of the filter guide, and
wherein the latch member enables the filter cover to move to the open position based on the filter assembly being inserted into the filter guide to a position that causes release of the latch member.

9. The filter guide according to claim 8, wherein the latch member is configured to rotate outward with respect to the filter cover based on the filter assembly being inserted into the filter guide to a position that causes release of the latch member.

10. The filter guide according to claim 8, wherein the latch member comprises:
a body portion having an upper end that is rotatably coupled to the filter guide;
a pressing projection positioned at an upper portion of the body portion and configured to be pressed by the filter assembly; and
a latching hook positioned at a lower portion of the body portion and configured to maintain the filter cover in the closed position by supporting a bottom surface of the filter cover.

11. The filter guide according to claim 10, wherein the pressing projection includes an inclined surface that is inclined in a downward direction with respect to an inserting direction of the filter assembly.

12. The filter guide according to claim 10, wherein a bottom side of the latching hook comprises an inclined surface that is inclined in an upward direction with respect to a rotating direction of the filter guide as it moves from the open position to the closed position.

13. The filter guide according to claim 10, wherein the latch member further includes a hinge shaft positioned at the upper end of the body portion, and wherein the filter guide includes a coupling hole to rotatably couple the hinge shaft therein.

14. The filter guide according to claim 10, where the filter guide includes:
a pressing opening configured to allow at least a portion of the pressing projection to pass through; and
a hook opening configured to allow at least a portion of the latching hook to pass through.

15. The filter guide according to claim 14, wherein the filter guide includes a front member having a front side wall and a rear member having a rear side wall, the front and rear members being assembled together, wherein the pressing opening is defined in the front side wall of the front member, and wherein the hook opening is defined in the rear side wall of the rear member.

16. The filter guide according to claim 8, wherein the latch member is one of a pair of latch members provided on opposite sides of the filter guide.

17. The filter guide according to claim 8, wherein the filter cover includes a latching part configured to be engaged by the latch member based on the latch member maintaining the filter cover in the closed position.

18. The filter guide according to claim 8, wherein the filter cover includes filter hinge shafts projecting outward from opposite sides of the filter cover, and wherein a side wall of the filter guide includes a hinge shaft hole configured to rotatably couple the filter hinge shaft therein.

19. The filter guide according to claim 18, further comprising a torsion spring positioned between the filter hinge shaft of the filter cover and the hinge shaft hole of the filter guide and configured to provide an elastic restitution force to the filter cover in a direction opposite of an inserting direction of the filter assembly.

20. A clothes-drying machine comprising:
a drum defining a cavity that receives clothes to be dried by the clothes-drying machine;
a cabinet that houses the drum and that defines an opening to enable loading of clothes into the drum and unloading of clothes from the drum;
a door configured to open and close to enable and inhibit access to the opening;
a filter assembly configured to filter foreign substances included in air exhausted from the drum; and
a filter guide positioned at a portion of the cabinet that defines the opening and defining a conduit that receives at least a portion of the filter assembly,
wherein the filter guide comprises:
a filter cover positioned within the conduit and configured to move back and forth between an open position and a closed position, the filter cover being configured to prevent items from moving past the filter cover when in the closed position, and
a pair of latch members provided on opposite sides of the filter guide, each of the pair of latch members having a pressing projection configured to be pressed by the filter assembly, and
a latching hook configured to maintain the filter cover in the closed position by supporting a bottom surface of the filter cover,
wherein the pair of latch member maintains the filter cover in the closed position based on the filter assembly being located outside of the filter guide, and
wherein the pair of latch member enables the filter cover to move to the open position based on the filter assembly being inserted into the filter guide and pressing the pressing projection of each of the pair of latch members, wherein pressing the pressing projection causes the latching hook to disengage from the filter cover.
